(19) United States
(12) Patent Application Publication
(10) Pub. No.: US 2026/0100044 A1
(43) Pub. Date: Apr. 9, 2026

(54) Interactive Digital Display Device

(71) Applicant: Matthew Blake Skillman, Eden Prairie, MN (US)

(72) Inventor: Matthew Blake Skillman, Eden Prairie, MN (US)

(21) Appl. No.: 18/910,135

(22) Filed: Oct. 9, 2024

(51) Int. Cl. G06V 20/52; G06F 3/0488; G06Q 30/0251; G06V 10/70; G06V 20/40; G06V 40/16; H04N 7/18; H04N 23/54

(52) U.S. Cl. CPC G06V 20/52; G06Q 30/0271; G06V 10/70; G06V 20/40; G06V 40/172; H04N 7/181; G06F 3/0488; H04N 23/54

(57) ABSTRACT

The present invention is directed to a modular, multi-faceted digital advertising and surveillance device that integrates AI-driven facial recognition and demographic analysis to dynamically adapt content and security measures in real-time. The device features multiple high-resolution cameras, capacitive touchscreens, and advanced wireless communication capabilities, including geofencing, to deliver targeted advertisements and enhance security monitoring. The system is designed for various applications, including retail, transportation hubs, and hospitality environments, providing a versatile solution that merges advertising and surveillance into a single, cohesive platform.

### BACKGROUND OF THE INVENTION

The present invention relates to both digital advertising and surveillance. More particularly, it is directed to an improved device that integrates real-time interactive digital
advertising with advanced surveillance capabilities within a single, unified system. This device is specifically designed to not only display advertisements but also to dynamically adapt its content and security features based on real-time data, providing a comprehensive solution for commercial and public settings.

Traditional digital displays used for advertising in public spaces are largely passive, presenting content without any form of interaction or data collection. These systems fail to adapt to the specific demographics and behaviors of the audience. Furthermore, surveillance systems typically operate independently of advertising systems, leading to inefficiencies in both security and marketing efforts. This separation often results in higher operational costs and less effective data utilization.

The present invention overcomes these limitations by combining digital advertising with sophisticated surveillance functionalities within a single device, offering unprecedented synergy between these two domains. Unlike existing systems that either focus on advertising or surveillance, this invention uniquely integrates these capabilities into a cohesive system that leverages advanced AI algorithms to dynamically adapt both marketing and security responses in

real-time, creating a solution that is greater than the sum of its parts.

Specifically, the device employs up to four AXIS FA-54 cameras, each equipped with multiple video feed lenses capable of capturing high-resolution, eye-level surveillance footage. This setup provides comprehensive coverage that can significantly reduce incidents of shoplifting and other unwanted behavior. The device's AI-driven facial recognition technology is integrated directly with the cameras, allowing it to not only detect and identify individuals but also to analyze demographic information such as age, gender, and mood. This data is then used to tailor the advertising content displayed, ensuring that the messaging is highly relevant to the viewer. The AI algorithms utilized within the device are designed with modularity and adaptability in mind. These algorithms can be customized and optimized depending on the deployment environment. For instance, in a retail setting, the facial recognition AI might prioritize demographic analysis and customer behavior tracking to tailor advertisements more effectively. Conversely, in a security-focused environment such as a transportation hub, the same algorithms can be configured to enhance threat detection and anomaly recognition. The system supports the integration of different AI models, allowing for the easy substitution or enhancement of algorithms as new techniques or requirements emerge. This adaptability ensures that the device

remains effective across a wide range of applications and can evolve in response to emerging technologies and changing market demands.

The device's hardware configuration includes multiple mounting options-countertop, shelf-mounted brackets, and potential future iterations such as ceiling-mounted brackets—making it adaptable to various environments. The integrated cameras can seamlessly feed into existing security systems, and the device can either display advertisements or surveillance footage depending on the context. Additionally, the cameras can be programmed to cross-reference individuals with databases of known shoplifters or the National Missing Children's Database, providing real-time alerts to security personnel when a match is detected.

### BRIEF SUMMARY OF THE INVENTION

The present invention is a multi-functional digital advertising and surveillance device, capable of providing tailored advertisements and advanced security monitoring within a single, integrated system. The device's displays can vary in size based on installation requirements and are wirelessly addressable and interactive through capacitive touchscreens. The device is equipped with multiple high-resolution cameras strategically positioned to offer nearly 360-degree coverage, capturing detailed footage for both marketing and security purposes. Marketing data collected includes metrics such as the number of customers present at a given time, peak foot traffic hours, and the density of patrons within specific areas, such as aisles in a store. The AI algorithms process this data in real-time, enabling the system to modify and optimize the content displayed on the screens instantaneously.

In addition to displaying advertisements, the device allows users to interact with the content via touchscreens, offering functionalities such as signing up for promotions, making immediate purchases, or conducting store-wide SKU lookups to check product availability and location. The system's interaction capabilities extend beyond basic touch functions, incorporating voice recognition and gesture control to cater to a wide range of user preferences.

The device's wireless communication system supports real-time, location-based push notifications to individuals near the units. This capability leverages Wi-Fi triangulation to determine the proximity of nearby smartphones or other connected devices with high accuracy. Wi-Fi triangulation works by analyzing the signal strength from multiple Wi-Fi access points to estimate a device's location relative to the display unit. This allows the system to trigger specific content, notifications, or alerts when a user's device is detected within a predefined range, extending the advertising reach beyond the screen itself. For example, as a customer walks past the device in a retail setting—or even outside the store—it can send a personalized promotional

offer or product recommendation directly to their smartphone, enhancing the shopping experience and drawing them into the store.

### BRIEF DESCRIPTION OF THE DRAWINGS

FIG. 1 shows a perspective view of the device of the invention.

FIG. 2A shows a perspective view of a first side of the device.

FIG. 2B shows a perspective view of a first side of the device.

FIG. 3 shows a perspective view of the device with one panel open.

FIG. 4 shows a view of the device in use.

### DETAILED DESCRIPTION OF THE PREFERRED EMBODIMENTS

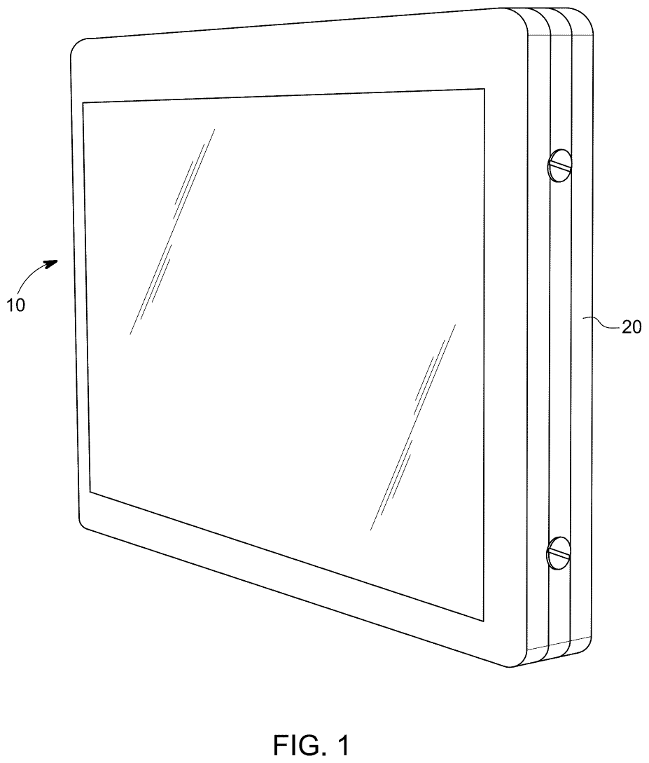

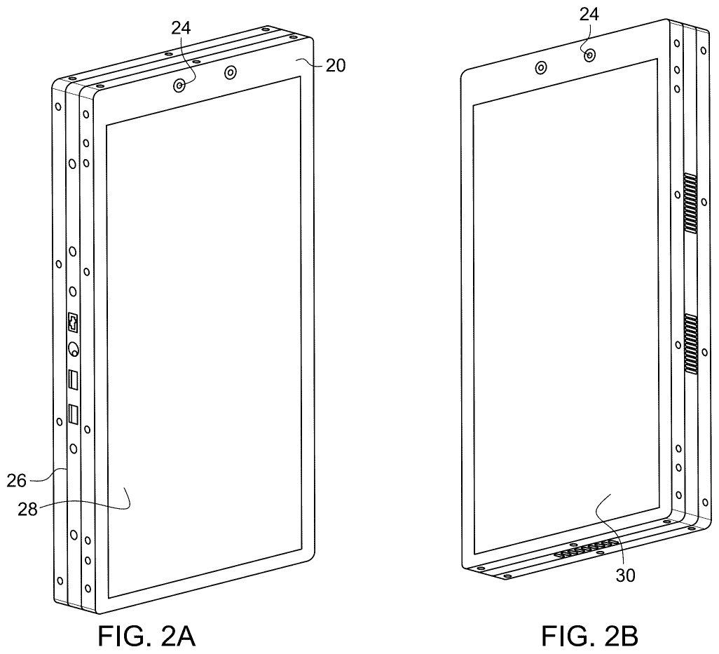

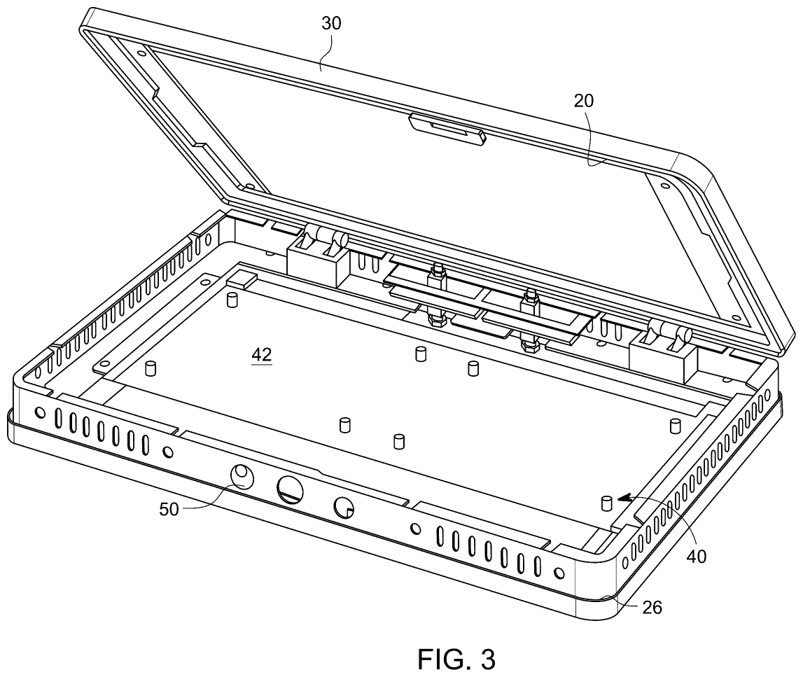

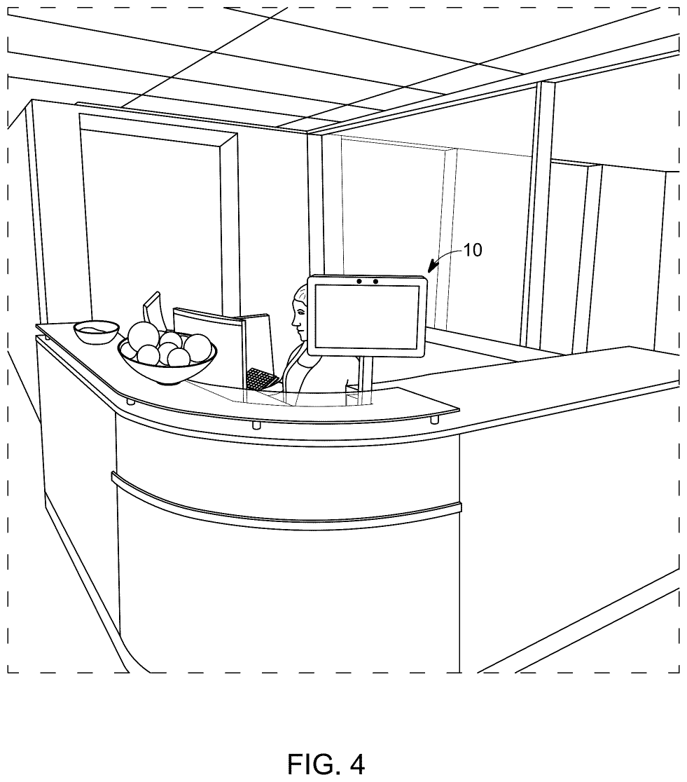

The present invention, as illustrated in FIGS. 1-4, provides a comprehensive point-of-sale advertising and surveillance solution within a single apparatus. The device, indicated by the numeral 10, comprises a dual-sided display 20, which is constructed with a robust housing 26 that integrates multiple high-resolution cameras 24. Each camera is equipped with advanced optics and is strategically positioned at the top of the display panels 28 and 30 to maximize coverage, achieving nearly 360 degrees of surveillance. The display panels are typically LCD, though they may also employ other advanced display technologies such as OLED or quantum dot displays, depending on the application requirements.

The cameras 24 are capable of capturing and processing high-resolution video streams in real-time, which are then analyzed by the device's onboard AI processors. These processors are based on a neural network architecture designed to perform complex image recognition tasks, including facial recognition, demographic analysis, and behavioral pattern detection. The captured video is not only used for security purposes but also feeds into the system's marketing algorithms,

allowing the device to adjust the displayed content based on the detected characteristics of individuals within its field of view.

The internal circuitry 40, mounted on the circuit board 42 within the housing, manages the data flow between the cameras, display panels, and the central processing unit. The circuitry is designed to support both wired and wireless connectivity, allowing the device to integrate seamlessly into existing network infrastructures. The device can operate autonomously or as part of a larger network of similar units, with data being centrally managed through a cloud-based platform that coordinates the distribution and analysis of marketing and security data. The dual-sided display 20 features touchscreens on both sides, utilizing capacitive touch technology for accurate and responsive user interactions. The touchscreens support multi-touch gestures, allowing users to interact with advertisements by selecting options, expanding content, or navigating through multiple layers of information.

One of the novel features of the device is its advanced voice recognition system, which is integrated into the microphone arrays embedded within the display housing. This system allows users to interact with the device using natural language commands, further enhancing the interactive experience and enabling the device to respond accurately to a wide range of user inputs.

The device's geofencing capabilities are implemented through advanced Wi-Fi triangulation technology, allowing the system to detect the proximity of users and trigger specific actions or content based on their location within a defined area. While geofencing is not the core feature of the device, it serves as a valuable add-on that expands the reach of the advertising platform beyond the screen itself. This feature is particularly valuable in retail environments, where it can deliver targeted promotions or product information to customers as they approach specific products or sections of the store, or even when walking by the store outside. The geofencing system is also designed to seamlessly integrate with third-party mobile applications, enabling retailers to extend the device's functionality directly to customers'smartphones, providing a cohesive and personalized shopping experience.

### APPLICATIONS

The device's versatility makes it suitable for a wide range of applications across various industries.

### Retail Stores

The device can be installed in grocery stores to serve advertisements related to current promotions while also monitoring for shoplifting. Its ability to cross-reference shoplifters with external databases and provide real-time alerts enhances store security.

### Gas Stations and Convenience Stores

In these locations, the device can be used to promote in-store products, provide directions to the nearest gas pump, or alert customers to special offers based on their purchasing history.

### Casinos

Casinos can use the device to advertise promotions, events, or new games while simultaneously monitoring the gaming floor for security threats or detecting underage patrons.

### Farm Co-Ops

The device can provide advertisements for agricultural products, tools, and services, while also offering real-time updates on weather conditions or market prices for crops. Surveillance features can help prevent theft of equipment or livestock.

### Outdated Retail Stores (e.g., CVS, Walgreens)

In stores with aging infrastructure, the device can modernize the shopping experience by offering digital advertisements, customer engagement through interactive screens, and enhanced security monitoring.

### Pubs and Bars

The device can be used in pubs to reduce altercations through advanced surveillance while offering customers the ability to place orders directly through the touchscreen. The device can also advertise products that are difficult to market elsewhere, such as alcohol, cannabis, and vaping products.

### Transportation Hubs

The device can manage crowd control in busy environments like airports or train stations, offering passengers real-time updates on gate changes, delays, or security alerts, while simultaneously providing targeted advertisements based on passenger demographics and travel history.

1. A device for displaying advertisements and monitoring human activity in a commercial setting comprising:
a display, the display having a housing with front and rear viewing screens positioned within front and rear display panels;
at least two cameras mounted on each side of each display panel;
networking and control circuitry contained within said housing;
whereby said device can interact with users to generate video streams based on user input or perceived preferences.

2. The device of claim 1 wherein at least one of said at least two cameras is used to obtain data useful for marketing.

3. The device of claim 2 wherein said data is a physical trait of a user.

4. The device of claim 2 wherein said data relates to apparel worn by the user.

5. The device of claim 1 wherein at least one of said at least two cameras is used to obtain security data.

6. The device of claim 5 wherein said security data may be monitored locally or remotely.

7. A method of using a device for displaying advertisements, generating sales, and monitoring human activity in a commercial setting comprising:
providing the device with a display, the display having a housing with front and rear viewing screens positioned within front and rear display panels;
providing the device with at least two cameras mounted on each side of each display panel;
whereby said device can interact with users to generate video streams based on user input or perceived preferences.

8. A device for displaying advertisements and monitoring human activity in a
commercial setting, comprising:
a. a housing with front and rear viewing screens, each of said viewing screens having a touch sensitive surface, said screens positioned within front and rear display panels;
b. a plurality of high-resolution cameras mounted on each side of each display panel, each camera having optics for capturing real-time video for both marketing and security purposes;
c. networking and control circuitry contained within said housing to manage data flow and image recognition, demographic analysis, and behavioral pattern detection;
d. said networking and control circuitry including software for facial recognition, ad serving, and surveillance, said software cross-referencing individuals with external databases to gather personal data, said software also including AI algorithms;
e. wherein said AI algorithms dynamically adapt advertising content and security responses based on real-time data analysis.

9. The device of claim 8, wherein AI-driven facial recognition software is integrated with high-resolution cameras to enhance security and tailor advertisements based on real-time demographic data.

10. The device of claim 8, wherein a data analytics system provides insights into foot traffic patterns, demographic trends, and user behavior, said system modifying content in real-time.

11. The device of claim 8 including a customized advertising portal that integrates with ad serving software for asset upload and approval, enabling centralized campaign management.

12. The device of claim 8, wherein the cameras are configured to provide augmented eye-level video surveillance, capable of identifying and cross-referencing individuals with security databases in real-time.

13. The device of claim 8, wherein a geofencing system is implemented using wireless communication technology, enabling the device to deliver targeted content based on user proximity.

14. The device of claim 8, wherein the cameras and AI algorithms detect specific behaviors including loitering or aggressive movements, and generating real-time security alerts.

15. The device of claim 8 wherein the system supports multi-device networking, allowing multiple units to operate in concert, providing a comprehensive security and advertising network.

16. The device of claim 1, wherein the AI algorithms are continuously updated through a cloud-based platform, ensuring the system remains at the cutting edge of both advertising and security technologies.
